(19) United States
(12) Patent Application Publication
(10) Pub. No.: US 2023/0023043 A1
(43) Pub. Date: Jan. 26, 2023

(54) OPTIMIZED MULTICHANNEL OPTICAL SYSTEM FOR LIDAR SENSORS

(71) Applicant: Waymo LLC, Mountain View, CA (US)

(72) Inventors: Chase Salsbury, Mountain View, CA (US); Michael R. Matthews, Portola Valley, CA (US)

(21) Appl. No.: 17/443,163

(22) Filed: Jul. 21, 2021

(51) Int. Cl. G01S 7/481; G01S 7/48; G01S 17/86; G01S 17/931; G02B 6/122; G02B 27/42

(52) U.S. Cl. CPC G01S 7/4811; G01S 7/4808; G01S 17/86; G01S 17/931; G01S 7/4817; G02B 6/1228; G02B 27/4233; G01S 7/4818

(57) ABSTRACT

The subject matter of this specification can be implemented in, among other things, systems and methods of optical sensing that utilize optimized processing of multiple sensing channels for efficient and reliable scanning of environments. The optical sensing includes multiple optical communication lines that include coupling portions configured to facilitate efficient collection of various received beams. The optical sensing system further includes multiple light detectors configured to process collected beams and produce data representative of a velocity of an object that generated the received beam and/or a distance to that object.

### TECHNICAL FIELD

The instant specification generally relates to range and velocity sensing in applications that involve determining locations and velocities of moving objects using optical signals reflected from the objects. More specifically, the instant specification relates to increasing a number of sensing channels of a light detection and ranging (lidar) device using optimized multichannel optical systems.

### BACKGROUND

Various automotive, aeronautical, marine, atmospheric, industrial, and other applications that involve tracking locations and motion of objects benefit from optical and radar detection technology. A rangefinder (radar or optical) device operates by emitting a series of signals that travel to an object and then detecting signals reflected back from the object. By determining a time delay between a signal emission and an arrival of the reflected signal, the rangefinder can determine a distance to the object. Additionally, the rangefinder can determine the velocity (the speed and the direction) of the object's motion by emitting two or more signals in a quick succession and detecting a changing position of the object with each additional signal. Coherent rangefinders, which utilize the Doppler effect, can determine a longitudinal (radial) component of the object's velocity by detecting a change in the frequency of the arrived wave from the frequency of the emitted signal. When the object is moving away from (or towards) the rangefinder, the frequency of the arrived signal is lower (higher) than the frequency of the emitted signal, and the change in the frequency is proportional to the radial component of the object's velocity. Autonomous (self-driving) vehicles operate by sensing an outside environment with various electromagnetic (radio, optical, infrared) sensors and charting a driving path through the environment based on the sensed data. Additionally, the driving path can be determined based on positioning (e.g., Global Positioning System (GPS)) and road map data. While the positioning and the road map data can provide information about static aspects of the environment (buildings, street layouts, etc.), dynamic information (such as information about other vehicles, pedestrians, cyclists, etc.) is obtained from contemporaneous electromagnetic sensing data. Precision and safety of the driving path and of the speed regime selected by the autonomous vehicle depend on the quality of the sensing data and on the ability of autonomous driving computing systems to process the sensing data and to provide appropriate instructions to the vehicle controls and the drivetrain.

### BRIEF DESCRIPTION OF THE DRAWINGS

The present disclosure is illustrated by way of examples, and not by way of limitation, and can be more fully understood with references to the following detailed description when considered in connection with the figures, in which:

FIG. 1 is a diagram illustrating components of an example autonomous vehicle that can deploy a lidar device capable of detecting and processing multiple reflected beams (channels), in accordance with some aspects of the present disclosure.

FIG. 2 is a block diagram illustrating an example implementation of an optical sensing system that utilizes optimized processing of multiple sensing channels for efficient and reliable scanning of environments, in accordance with some aspects of the present disclosure.

FIGS. 3A-3D are schematic depictions of example optimized coupling of multiple received reflected beams to optical communication lines (OCLs) for improved performance of lidar devices, in accordance with some aspects of the present disclosure. FIG. 3A depicts coupling of different received beams to on-axis and off-axis optical fibers that have similar configurations. FIG. 3B depicts coupling of different received beams to on-axis and off-axis optical fibers that have different numerical apertures. FIG. 3C depicts coupling of different received beams to on-axis and off-axis optical fibers that have different facet angles. FIG. 3D depicts coupling of different received beams to optical fibers that have different facet angles and a net angle tilt.

FIGS. 4A-4D are schematic depictions of example geometries of coupling portions of off-axis optical fibers for improved coupling to received beams in lidar devices, in accordance with some aspects of the present disclosure. FIG. 4A depicts a coupling portion having a concave end. FIG. 4B depicts a coupling portion having a convex end. FIG. 4C depicts a coupling portion having multiple curvatures, such as a convex curvature for fiber optic core and concave curvature for cladding. FIG. 4D depicts a coupling portion that has a modulation (e.g., grating) etched on (or otherwise imparted to) the end of the fiber.

FIG. 5A depicts schematically an example setup that deploys diffractive optical elements for improved coupling of multiple reflected beams to OCLs in lidar devices, in accordance with some aspects of the present disclosure.

FIG. 5B depicts schematically an example array of multiple diffractive optical elements configured to improve coupling between reflected beams and OCLs in lidar devices, in accordance with some aspects of the present disclosure.

FIG. 6A depicts schematically an example system of OCLs implemented as part of a photonic integrated circuit, in accordance with some aspects of the present disclosure.

FIG. 6B depicts schematically another example system of OCLs implemented as part of a photonic integrated circuit, in accordance with some aspects of the present disclosure.

FIG. 6C depicts schematically yet another example system of OCLs implemented as part of a photonic integrated circuit, in which waveguide openings are inline with an edge of the photonic integrated circuit, in accordance with some aspects of the present disclosure.

FIG. 6D depicts schematically yet another example system of OCLs implemented as part of a photonic integrated circuit, in which OCLs have a net angle tilt, in accordance with some aspects of the present disclosure.

FIG. 7 depicts a flow diagram of an example method of using an optical sensing system that utilizes optimized processing of multiple sensing channels for efficient and reliable scanning of environments, in accordance with some aspects of the present disclosure

### SUMMARY

In one implementation, disclosed is a system that includes a front-end optics configured to focus a plurality of received beams and a plurality of optical communication lines (OCLs), wherein each OCL in the plurality of OCLs is configured with a coupling portion to collect a corresponding beam of the focused plurality of received beams, wherein the coupling portion of a first OCL in the plurality of OCLs is configured differently than the coupling portion of a second OCL in the plurality of OCLs. The system further includes a plurality of light detectors, wherein each of the plurality of light detectors is configured to: detect a respective beam of the plurality of beams collected by the coupling portion of a respective OCL in the plurality of OCLs; and generate, based on the detected beam, data representative of at least one of (i) a velocity of an object that generated the detected beam or (ii) a distance to the object that generated the detected beam.

In another implementation, disclosed is a system that includes an optical subsystem configured to: output, to an outside environment, a plurality of transmitted beams; receive, from the outside environment, a first beam generated upon interaction of a first transmitted beam of the plurality of transmitted beams with a first object in the outside environment; and focus the received first beam at a first coupling portion of a first OCL in a plurality of OCLs, wherein the coupling portion of the first OCL is configured differently than the coupling portion of a second OCL in the plurality of OCLs. The system further includes a light detection subsystem configured to: obtain, via the first OCL, the first beam; and generate, based on the obtained first beam, a first electronic signal; and one or more circuits, operatively coupled with the light detection subsystem and configured to determine, based on the first electronic signal, at least one of a velocity of the first object or a distance to the first object.

In another implementation, disclosed is a method of outputting, to an outside environment, a plurality of transmitted beams; receiving, from the outside environment, a first beam generated upon interaction of a first transmitted beam of the plurality of transmitted beams with a first object in the outside environment; focusing the received first beam at a coupling portion of a first OCL in a plurality of OCLs, wherein the coupling portion of the first OCL is configured differently than the coupling portion of a second OCL in the plurality of OCLs; providing, via the first OCL, the first beam to a first light detector; generating, using the first light detector and based on the provided first beam, a first electronic signal; and determining, based on the first electronic signal, at least one of a velocity of the first object or a distance to the first object.

### DETAILED DESCRIPTION

An autonomous vehicle can employ a light detection and ranging (lidar) technology to detect distances to various objects in the environment and, sometimes, the velocities of such objects. A lidar emits one or more laser signals (pulses) that travel to an object and then detects arrived signals reflected from the object. By determining a time delay between the signal emission and the arrival of the reflected waves, a time-of-flight (ToF) lidar can determine the distance to the object. A typical lidar emits signals in multiple directions to obtain a wide view of the outside environment. For example, a lidar device can cover (e.g., scan) an entire 360-degree view by collecting a series of consecutive frames identified with timestamps. As a result, each sector in space is sensed in time increments Δτ, which are determined by the angular velocity of the lidar's scanning speed. Sometimes, an entire 360-degree view of the environment can be obtained over a scan of the lidar. Alternatively, any smaller sector, e.g., a 1-degree sector, a 5-degree sector, a 10-degree sector, or any other sector can be scanned, as desired.

ToF lidars can also be used to determine velocities of objects in the environment, e.g., by detecting two (or more) locations \vec{r}(t₁), \vec{r}(t₂) of some reference point of an object (e.g., the front end of a vehicle) and inferring the velocity as the ratio, \vec{v}=[\vec{r}(t₂)−\vec{r}(t₁)]/[t₂−t₁]. By design, the measured velocity \vec{v} is not the instantaneous velocity of the object but rather the velocity averaged over the time interval t₂−t₁, as the ToF technology does not allow to ascertain whether the object maintained the same velocity \vec{v} during this time or experienced an acceleration or deceleration (with detection of acceleration/deceleration requiring additional locations \vec{r}(t₃), \vec{r}(t₄) . . . of the object).

Coherent lidars operate by detecting, in addition to ToF, a change in the frequency of the reflected signal—the Doppler shift—indicative of the velocity of the reflecting surface. Measurements of the Doppler shift can be used to determine, based on a single sensing frame, radial components (along the line of beam propagation) of the velocities of various reflecting points belonging to one or more objects in the environment (such as vehicles, motorcyclists, bicyclists, pedestrians, road signs, buildings, trees, and the like). A signal emitted by a coherent lidar can be modulated (in frequency and/or phase) with a radio frequency (RF) signal prior to being transmitted to a target. A local copy of the transmitted signal can be maintained on the lidar and mixed with a signal reflected from the target; a beating pattern between the two signals can then be extracted and Fourier-analyzed to determine the Doppler shift and identify the radial velocity of the target.

Increasing frequency and efficiency of lidar scanning can be beneficial in many applications of the lidar technology, including but not limited to autonomous vehicles. A driving environment of an autonomous vehicle can include hundreds of objects. Simultaneously producing and detecting multiple beams (sensing channels) can reduce the time needed to obtain a complete sensing picture of the environment. However, using additional lasers, optical modulators, amplifiers, lenses, and other components to scale up the number of output channels comes with a considerable cost and affects the size, weight, and complexity of lidar sensors. A multichannel lidar sensor can share some of the components among multiple channels. For example, shared components can be lasers, lenses, digital signal processing components, and the like. Yet it can be difficult to ensure that all channels have similarly high signal-to-noise ratios (SNRs). More specifically, multiple optical fibers can be positioned behind an objective lens to collect sensing beams arriving through the objective lens from various directions. The collected light can then be processed by independent photodetectors to extract coherence information representative of a distance and a state of motion of various objects. However, optical aberration and different optical paths travelled by the incoming beams and focused by the objective lens on different fibers can disfavor some of the channels. For example, a channel that uses an off-axis fiber (e.g., a fiber that is located away from an optical axis of the objective lens) can have a weaker SNR than the channel that uses an on-axis fiber.

Aspects and implementations of the present disclosure enable methods and systems that achieve reliable channel multiplexing using an optical receiver that utilizes OCLs specifically engineered to ensure improved coupling to received (and transmitted) beams of the electromagnetic field. OCLs can include dielectric optical fibers (e.g., tubes that use total internal reflection to guide light), waveguides (e.g., conducting hollow waveguides, conducting dielectric-filled waveguides, etc.), prism light guides, hollow pipes with metallic coatings, metallic mirror light guides, multi-layered light-guiding dielectric structures, photonic-crystal fibers, or any other suitable devices and structures. In the instant disclosure, whenever a reference to a waveguide or an optical fiber is made, it should be understood that OCLs of various other types can be used instead of the optical fiber or waveguide. In some implementations, OCLs may include multiple portions of different types, e.g., an OCL may include an optical fiber portion and a waveguide portion, an optical fiber portion and a photonic-crystal portion, or any combination of portions of suitable OCL types. In some implementations, an off-axis fiber or an off-axis waveguide can have an end (coupling portion) that is cut (or otherwise engineered) at such a direction to the axis of the fiber/waveguide that increases a portion of the electromagnetic energy captured by the fiber/waveguide. In some implementations, various fibers/waveguides have different and specially engineered numerical apertures to increase coupling. In some implementations, additional optical elements, such as diffraction gratings or holographic elements can provide directional coupling of the received light to a target OCL. The advantages of the disclosed implementations include, but are not limited to, improving SNR for multiple beams of light that are received from (or transmitted to) different directions. Increasing the number of lidar channels that provide reliable sensing data shortens the time of scanning outside environments and thus improves the safety of lidar-based applications, such as autonomous driving.

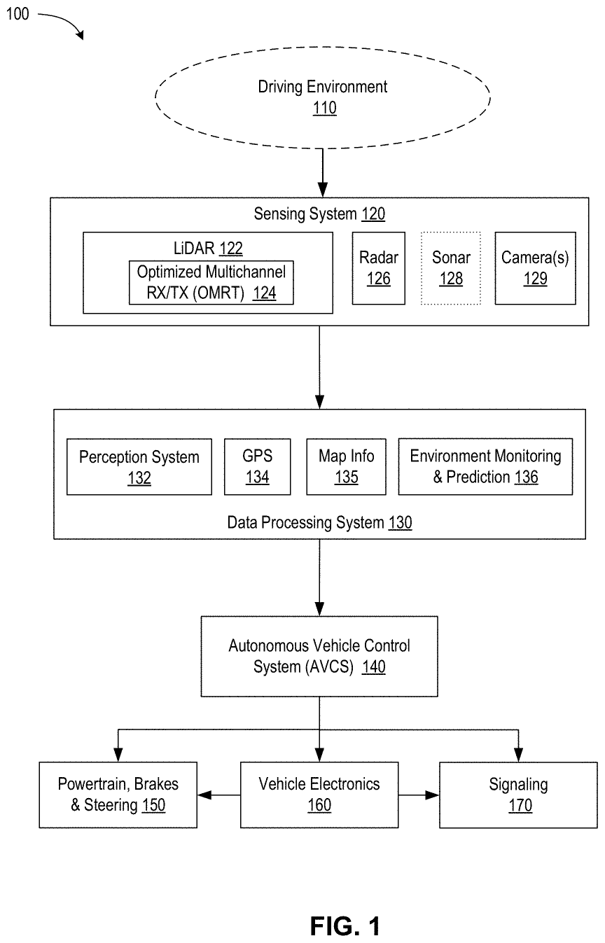

FIG. 1 is a diagram illustrating components of an example autonomous vehicle (AV) 100 that can deploy a lidar device capable of detecting and processing multiple reflected beams (channels), in accordance with some implementations of the present disclosure. Autonomous vehicles can include motor vehicles (cars, trucks, buses, motorcycles, all-terrain vehicles, recreational vehicle, any specialized farming or construction vehicles, and the like), aircraft (planes, helicopters, drones, and the like), naval vehicles (ships, boats, yachts, submarines, and the like), or any other self-propelled vehicles (e.g., robots, factory or warehouse robotic vehicles, sidewalk delivery robotic vehicles, etc.) capable of being operated in a self-driving mode (without a human input or with a reduced human input).

A driving environment 110 can include any objects (animated or non-animated) located outside the AV, such as roadways, buildings, trees, bushes, sidewalks, bridges, mountains, other vehicles, pedestrians, and so on. The driving environment 110 can be urban, suburban, rural, and so on. In some implementations, the driving environment 110 can be an off-road environment (e.g. farming or agricultural land). In some implementations, the driving environment can be an indoor environment, e.g., the environment of an industrial plant, a shipping warehouse, a hazardous area of a building, and so on. In some implementations, the driving environment 110 can be substantially flat, with various objects moving parallel to a surface (e.g., parallel to the surface of Earth). In other implementations, the driving environment can be three-dimensional and can include objects that are capable of moving along all three directions (e.g., balloons, leaves, etc.). Hereinafter, the term “driving environment” should be understood to include all environments in which motion of self-propelled vehicles can occur. For example, “driving environment” can include any possible flying environment of an aircraft or a marine environment of a naval vessel. The objects of the driving environment 110 can be located at any distance from the AV, from close distances of several feet (or less) to several miles (or more).

The example AV 100 can include a sensing system 120. The sensing system 120 can include various electromagnetic (e.g., optical) and non-electromagnetic (e.g., acoustic) sensing subsystems and/or devices. The terms “optical” and “light,” as referenced throughout this disclosure, are to be understood to encompass any electromagnetic radiation (waves) that can be used in object sensing to facilitate autonomous driving, e.g., distance sensing, velocity sensing, acceleration sensing, rotational motion sensing, and so on. For example, “optical” sensing can utilize a range of light visible to a human eye (e.g., the 380 to 700 nm wavelength range), the UV range (below 380 nm), the infrared range (above 700 nm), the radio frequency range (above 1 m), etc. In implementations, “optical” and “light” can include any other suitable range of the electromagnetic spectrum.

The sensing system 120 can include a radar unit 126, which can be any system that utilizes radio or microwave frequency signals to sense objects within the driving environment 110 of the AV 100. The radar unit 126 can be configured to sense both the spatial locations of the objects (including their spatial dimensions) and their velocities (e.g., using the radar Doppler shift technology). The sensing system 120 can include a lidar sensor 122 (e.g., a lidar rangefinder), which can be a laser-based unit capable of determining distances to the objects in the driving environment 110 as well as, in some implementations, velocities of such objects. The lidar sensor 122 can utilize wavelengths of electromagnetic waves that are shorter than the wavelength of the radio waves and can thus provide a higher spatial resolution and sensitivity compared with the radar unit 126. The lidar sensor 122 can include a ToF lidar and/or a coherent lidar sensor, such as a frequency-modulated continuous-wave (FMCW) lidar sensor, phase-modulated lidar sensor, amplitude-modulated lidar sensor, and the like. Coherent lidar sensor can use optical heterodyne detection for velocity determination. In some implementations, the functionality of the ToF lidar sensor and coherent lidar sensor can be combined into a single (e.g., hybrid) unit capable of determining both the distance to and the radial velocity of the reflecting object. Such a hybrid unit can be configured to operate in an incoherent sensing mode (ToF mode) and/or a coherent sensing mode (e.g., a mode that uses heterodyne detection) or both modes at the same time. In some implementations, multiple lidar sensor units can be mounted on AV, e.g., at different locations separated in space, to provide additional information about a transverse component of the velocity of the reflecting object.

Lidar sensor 122 can include one or more laser sources producing and emitting signals and one or more detectors of the signals reflected back from the objects. Lidar sensor 122 can include spectral filters to filter out spurious electromagnetic waves having wavelengths (frequencies) that are different from the wavelengths (frequencies) of the emitted signals. In some implementations, lidar sensor 122 can include directional filters (e.g., apertures, diffraction gratings, and so on) to filter out electromagnetic waves that can arrive at the detectors along directions different from the reflection directions for the emitted signals. Lidar sensor 122 can use various other optical components (lenses, mirrors, gratings, optical films, interferometers, spectrometers, local oscillators, and the like) to enhance sensing capabilities of the sensors.

In some implementations, lidar sensor 122 can include one or more 360-degree scanning units (which scan the environment in a horizontal direction, in one example). In some implementations, lidar sensor 122 can be capable of spatial scanning along both the horizontal and vertical directions. In some implementations, the field of view can be up to 90 degrees in the vertical direction (e.g., with at least a part of the region above the horizon scanned by the lidar signals or with at least part of the region below the horizon scanned by the lidar signals). In some implementations (e.g., in aeronautical environments), the field of view can be a full sphere (consisting of two hemispheres). For brevity and conciseness, when a reference to “lidar technology,” “lidar sensing,” “lidar data,” and “lidar,” in general, is made in the present disclosure, such reference shall be understood also to encompass other sensing technology that operate, generally, at the near-infrared wavelength, but can include sensing technology that operate at other wavelengths as well as.

Lidar sensor 122 can include optimized multichannel receiver and transmitter (OMRT) 124 capable of improving reception and transmission of multiple sensing channels for more efficient and reliable scanning of the environment. OMRT 124 can include separate receiving (RX) and transmitting (TX) subsystems or a combined RX/TX system that uses at least some of the components to output the transmitted beams and receive the reflected beams. The components can include various apertures, lenses, mirrors, concave mirrors, diffraction gratings, holographic plates, and other optical elements to shape, direct, and output multiple transmitted beams in various directions and receive, focus, and deliver for processing multiple reflected beams that are generated upon interaction of the transmitted beams with objects in the environment. Various received beams can carry information associated with a state of motion of (e.g., speed and direction) and distance to various objects and serve as sensing probes for multiple sensing channels. Different sensing channels can utilize separate photodetectors to convert respective optical beams to electronic signals. The electronic signals can be representative of a difference between a phase information carried by the received beams and a phase information imparted to the transmitted beams (and available to the photodetectors, in the form of local oscillator copies). The electronic signals representative of phase and amplitude of the received optical beams can be further processed by an electronics subsystem configured to extract such coherence information, e.g., in a radio frequency (RF) domain to determine a velocity of the object and/or a distance to the object.

The sensing system 120 can further include one or more cameras 129 to capture images of the driving environment 110. The images can be two-dimensional projections of the driving environment 110 (or parts of the driving environment 110) onto a projecting plane of the cameras (flat or non-flat, e.g. fisheye cameras). Some of the cameras 129 of the sensing system 120 can be video cameras configured to capture a continuous (or quasi-continuous) stream of images of the driving environment 110. The sensing system 120 can also include one or more sonars 128, which can be ultrasonic sonars, in some implementations.

The sensing data obtained by the sensing system 120 can be processed by a data processing system 130 of AV 100. In some implementations, the data processing system 130 can include a perception system 132. Perception system 132 can be configured to detect and track objects in the driving environment 110 and to recognize/identify the detected objects. For example, the perception system 132 can analyze images captured by the cameras 129 and can be capable of detecting traffic light signals, road signs, roadway layouts (e.g., boundaries of traffic lanes, topologies of intersections, designations of parking places, and so on), presence of obstacles, and the like. The perception system 132 can further receive the lidar sensing data (Doppler data and/or ToF data) to determine distances to various objects in the environment 110 and velocities (radial and transverse) of such objects. In some implementations, perception system 132 can use the lidar data in combination with the data captured by the camera(s) 129. In one example, the camera(s) 129 can detect an image of road debris partially obstructing a traffic lane. Using the data from the camera(s) 129, perception system 132 can be capable of determining the angular extent of the debris. Using the lidar data, the perception system 132 can determine the distance from the debris to the AV and, therefore, by combining the distance information with the angular size of the debris, the perception system 132 can determine the linear dimensions of the debris as well.

In another implementation, using the lidar data, the perception system 132 can determine how far a detected object is from the AV and can further determine the component of the object's velocity along the direction of the AV's motion. Furthermore, using a series of quick images obtained by the camera, the perception system 132 can also determine the lateral velocity of the detected object in a direction perpendicular to the direction of the AV's motion. In some implementations, the lateral velocity can be determined from the lidar data alone, for example, by recognizing an edge of the object (using horizontal scanning) and further determining how quickly the edge of the object is moving in the lateral direction. The perception system 132 can receive one or more sensor data frames from the sensing system 120. Each of the sensor frames can include multiple points. Each point can correspond to a reflecting surface from which a signal emitted by the sensing system 120 (e.g., lidar sensor 122) is reflected. The type and/or nature of the reflecting surface can be unknown. Each point can be associated with various data, such as a timestamp of the frame, coordinates of the reflecting surface, radial velocity of the reflecting surface, intensity of the reflected signal, and so on.

The perception system 132 can further receive information from a positioning subsystem, which can include a GPS transceiver (not shown), configured to obtain information about the position of the AV relative to Earth and its surroundings. The positioning data processing module 134 can use the positioning data (e.g., GPS and IMU data) in conjunction with the sensing data to help accurately determine the location of the AV with respect to fixed objects of the driving environment 110 (e.g. roadways, lane boundaries, intersections, sidewalks, crosswalks, road signs, curbs, surrounding buildings, etc.) whose locations can be provided by map information 135. In some implementations, the data processing system 130 can receive non-electromagnetic data, such as audio data (e.g., ultrasonic sensor data, or data from a mic picking up emergency vehicle sirens), temperature sensor data, humidity sensor data, pressure sensor data, meteorological data (e.g., wind speed and direction, precipitation data), and the like.

Data processing system 130 can further include an environment monitoring and prediction component 136, which can monitor how the driving environment 110 evolves with time, e.g., by keeping track of the locations and velocities of the animated objects (relative to Earth). In some implementations, environment monitoring and prediction component 136 can keep track of the changing appearance of the environment due to motion of the AV relative to the environment. In some implementations, environment monitoring and prediction component 136 can make predictions about how various animated objects of the driving environment 110 will be positioned within a prediction time horizon. The predictions can be based on the current locations and velocities of the animated objects as well as on the tracked dynamics of the animated objects during a certain (e.g., predetermined) period of time. For example, based on stored data for object A indicating accelerated motion of object A during the previous 3-second period of time, environment monitoring and prediction component 136 can conclude that object A is resuming its motion from a stop sign or a red traffic light signal. Accordingly, environment monitoring and prediction component 136 can predict, given the layout of the roadway and presence of other vehicles, where object A is likely to be within the next 3 or 5 seconds of motion. As another example, based on stored data for object B indicating decelerated motion of object B during the previous 2-second period of time, environment monitoring and prediction component 136 can conclude that object B is stopping at a stop sign or at a red traffic light signal. Accordingly, environment monitoring and prediction component 136 can predict where object B is likely to be within the next 1 or 3 seconds. Environment monitoring and prediction component 136 can perform periodic checks of the accuracy of its predictions and modify the predictions based on new data obtained from the sensing system 120.

The data generated by the perception system 132, the GPS data processing module 134, and environment monitoring and prediction component 136 can be used by an autonomous driving system, such as AV control system (AVCS) 140. The AVCS 140 can include one or more algorithms that control how AV is to behave in various driving situations and environments. For example, the AVCS 140 can include a navigation system for determining a global driving route to a destination point. The AVCS 140 can also include a driving path selection system for selecting a particular path through the immediate driving environment, which can include selecting a traffic lane, negotiating a traffic congestion, choosing a place to make a U-turn, selecting a trajectory for a parking maneuver, and so on. The AVCS 140 can also include an obstacle avoidance system for safe avoidance of various obstructions (rocks, stalled vehicles, a jaywalking pedestrian, and so on) within the driving environment of the AV. The obstacle avoidance system can be configured to evaluate the size of the obstacles and the trajectories of the obstacles (if obstacles are animated) and select an optimal driving strategy (e.g., braking, steering, accelerating, etc.) for avoiding the obstacles.

Algorithms and modules of AVCS 140 can generate instructions for various systems and components of the vehicle, such as the powertrain, brakes, and steering 150, vehicle electronics 160, signaling 170, and other systems and components not explicitly shown in FIG. 1. The powertrain, brakes, and steering 150 can include an engine (internal combustion engine, electric engine, and so on), transmission, differentials, axles, wheels, steering mechanism, and other systems. The vehicle electronics 160 can include an on-board computer, engine management, ignition, communication systems, carputers, telematics, in-car entertainment systems, and other systems and components. The signaling 170 can include high and low headlights, stopping lights, turning and backing lights, horns and alarms, inside lighting system, dashboard notification system, passenger notification system, radio and wireless network transmission systems, and so on. Some of the instructions outputted by the AVCS 140 can be delivered directly to the powertrain, brakes, and steering 150 (or signaling 170) whereas other instructions output by the AVCS 140 are first delivered to the vehicle electronics 160, which generate commands to the powertrain and steering 150 and/or signaling 170.

In one example, the AVCS 140 can determine that an obstacle identified by the data processing system 130 is to be avoided by decelerating the vehicle until a safe speed is reached, followed by steering the vehicle around the obstacle. The AVCS 140 can output instructions to the powertrain, brakes, and steering 150 (directly or via the vehicle electronics 160) to 1) reduce, by modifying the throttle settings, a flow of fuel to the engine to decrease the engine rpm, 2) downshift, via an automatic transmission, the drivetrain into a lower gear, 3) engage a brake unit to reduce (while acting in concert with the engine and the transmission) the vehicle's speed until a safe speed is reached, and 4) perform, using a power steering mechanism, a steering maneuver until the obstacle is safely bypassed. Subsequently, the AVCS 140 can output instructions to the powertrain, brakes, and steering 150 to resume the previous speed settings of the vehicle.

The “autonomous vehicle” can include motor vehicles (cars, trucks, buses, motorcycles, all-terrain vehicles, recreational vehicle, any specialized farming or construction vehicles, and the like), aircrafts (planes, helicopters, drones, and the like), naval vehicles (ships, boats, yachts, submarines, and the like), robotic vehicles (e.g., factory, warehouse, sidewalk delivery robots) or any other self-propelled vehicles capable of being operated in a self-driving mode (without a human input or with a reduced human input). “Objects” can include any entity, item, device, body, or article (animate or inanimate) located outside the autonomous vehicle, such as roadways, buildings, trees, bushes, sidewalks, bridges, mountains, other vehicles, piers, banks, landing strips, animals, birds, or other things.

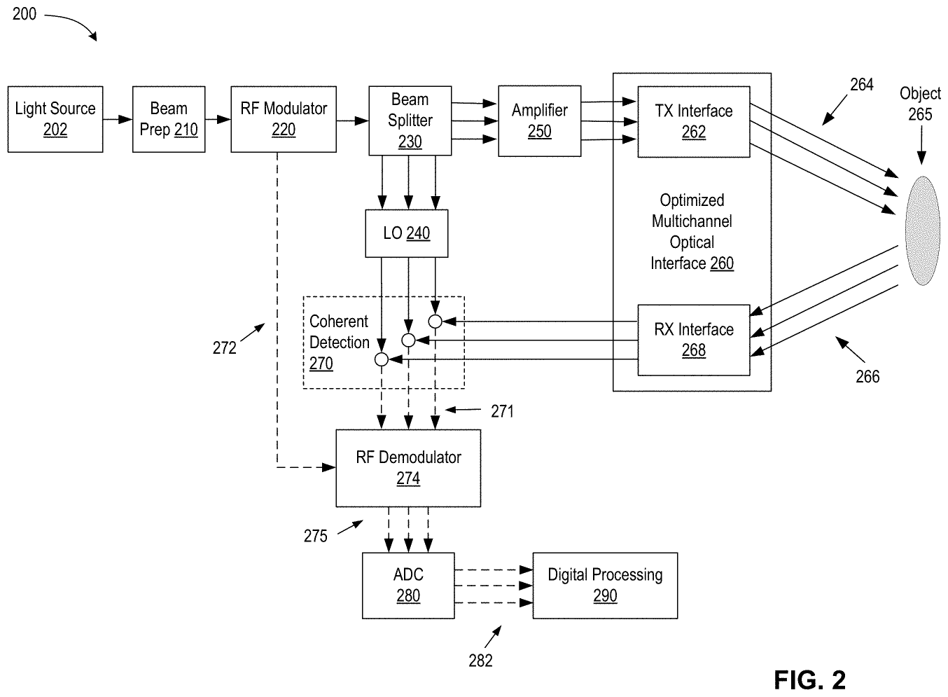

FIG. 2 is a block diagram illustrating an example implementation of an optical sensing system 200 (e.g., as part of sensing system 120) that utilizes optimized processing of multiple sensing channels for efficient and reliable scanning of environments, in accordance with some aspects of the present disclosure. Sensing system 200 can be a part of lidar sensor 122 that deploys OMRT 124. Depicted in FIG. 2 is a light source 202 configured to produce one or more beams of light. “Beams” should be understood herein as referring to any signals of electromagnetic radiation, such as beams, wave packets, pulses, sequences of pulses, or other types of signals. Solid arrows indicate optical signal propagation and dashed arrows depict propagation of electronic (e.g., RF or other analog or digital) signals. Light source 202 can be a broadband laser, a narrow-band laser, a light-emitting diode, a Gunn diode, and the like. Light source 202 can be a semiconductor laser, a gas laser, an ND:YAG laser, or any other type of a laser. Light source 202 can be a continuous wave laser, a single-pulse laser, a repetitively pulsed laser, a mode locked laser, and the like.

In some implementations, light output by the light source 202 can be conditioned (pre-processed) by one or more components or elements of a beam preparation stage 210 of the optical sensing system 200 to ensure a narrow-band spectrum, target linewidth, coherence, polarization (e.g., circular or linear), and other optical properties that enable coherent (e.g., Doppler) measurements described below. Beam preparation can be performed using filters (e.g., narrow-band filters), resonators (e.g., resonator cavities, crystal resonators, etc.), polarizers, feedback loops, lenses, mirrors, diffraction optical elements, and other optical devices. For example, if light source 202 is a broadband light source, the output light can be filtered to produce a narrowband beam. In some implementations, where light source 202 produces light that has a desired linewidth and coherence, the light can still be additionally filtered, focused, collimated, diffracted, amplified, polarized, etc., to produce one or more beams of a desired spatial profile, spectrum, duration, frequency, polarization, repetition rate, and so on. In some implementations, light source 202 can produce a narrow-linewidth light with a linewidth below 100 KHz.

After the light beam is configured by beam preparation stage 210, an RF modulator 220 can impart angle modulation to the prepared beam, e.g., using one or more RF circuits, such as an RF local oscillator (LO), one or more mixers, amplifiers, filters, and the like. For brevity and conciseness, modulation is referred herein as being performed with RF signals, other frequencies can also be used for angle modulation, including but not limited to Terahertz signals, microwave signals, and so on. In some implementations, RF modulator 220 includes a generator of RF signal inputs into an optical modulator that modulates the light beam. “Optical modulation” is to be understood herein as referring to any form of angle modulation, such as phase modulation (e.g., any time sequence of phase changes Δϕ(t) added to the phase of the beam), frequency modulation (e.g., any sequence Δf(t) of frequency changes), or any other type of modulation (including a combination of a phase and a frequency modulation) that affects the phase of the wave. Optical modulation is also to be understood herein as to include, where applicable, amplitude modulation. Amplitude modulation can be applied to the beam in combination with angle modulation or separately, without angle modulation. In some implementations, the optical modulator can include an acousto-optic modulator, an electro-optic modulator, a Lithium Niobate modulator, a heat-driven modulator, a Mach-Zender modulator, and the like, or any combination thereof. In some implementations, angle modulation can add phase/frequency shifts that are continuous functions of time. In some implementations, added phase/frequency shifts can be discrete and can take on a number of values, e.g., N discrete values across the phase interval 2π. An optical modulator can add a predetermined time sequence of phase/frequency shifts to the light signal. In some implementations, a modulated RF signal can cause the optical modulator to impart to the light beam a sequence of frequency up-chirps interspersed with down-chirps. In some implementations, phase/frequency modulation can have a duration between a microsecond and tens of microseconds and can be repeated with a repetition rate ranging from one or several kilohertz to hundreds of kilohertz.

After optical modulation is performed, the light beam can undergo spatial separation at a beam splitter 230 to produce one or more local oscillator (LO) 240 copies of the modulated beam. The local oscillators 240 can be used as reference signals against which a signal reflected from an object can be compared. The beam splitter 230 can be a prism-based beam splitter, a partially-reflecting mirror, a polarizing beam splitter, a beam sampler, a fiber optical coupler (optical fiber adaptor), or any similar beam splitting element (or a combination of two or more beam-splitting elements). The light beam can be delivered to the beam splitter 230 (as well as between any other components depicted in FIG. 2) over air or over light carriers, e.g. OCLs, such as optical fibers or waveguides. In some implementations, all LOs 240 can receive the same RF modulation. For example, as depicted in FIG. 2, RF modulator 220 can be positioned prior to beam splitter 230. In other implementations, RF modulator 220 can be positioned after beam splitter 230, e.g., with at least some (or all) LOs 240 receiving different (from other LOs) angle modulation, such as a different sequence of up-chirps and down chirps, a different sequence of phase shifts, and the like.

The light beams can be amplified by amplifier 250 before being transmitted through an optimized multichannel optical interface 260 towards one or more objects 265 in the driving environment 110. Optical interface 260 can include one or more optical elements, e.g., apertures, lenses, mirrors, collimators, polarizers, waveguides, and the like, or any such combination of optical elements. Optical interface can include a TX interface 262 and an RX interface 268. In some implementations, some of the optical elements (e.g., lenses, mirrors, collimators, optical fibers, waveguides, beam splitters, and the like) can be shared by TX interface 262 and RX interface 268. The optical elements of the TX interface 262 can direct multiple output beams 264 to a target region in the outside environment. In some implementations, output beams 264 can be transmitted in a fan-like pattern with various output beams propagating along different directions, e.g., making angles of several degrees (or more) with other angles. As a result, different output beams 264 can reflect from different objects 265 (e.g., different vehicles) that are located at different distances and move with different velocities. The fan-like pattern of the beams can be rotating between different frames as part of the environment scanning.

Upon interaction with various objects, such as object 265, output beams 264 generate respective reflected beams 266 that propagate back towards the optical sensing system 200 and enter the system through RX interface 268. Because various reflected beams 266 can reflect from different objects, phase information (e.g., Doppler shift) and time of flight of each reflected beam 266 can be different from other reflected beams 266. For example, a first reflected beam can reflect off a stationary tree or a building and have no Doppler shift relative to the respective output beam 264, provided the optical sensing system 200 is not moving (such as when it is mounted on an autonomous vehicle that is stopped). A second reflected beam can reflect from a vehicle approaching the optical sensing system 200 and have a positive Doppler shift (such as when a vehicle is approaching an autonomous vehicle which includes optical sensing system 200). A third reflected beam can reflect from a vehicle moving away from the optical sensing system 200 and have a negative Doppler shift (such as when a vehicle is moving away from an autonomous vehicle which includes optical sensing system 200), and so on. Each of these objects can be at a different distance from the optical sensing system 200. The respective reflected beams can thus arrive with a different ToF-caused shift of the angle modulation (relative to the corresponding LO 240 retained by the sensing system).

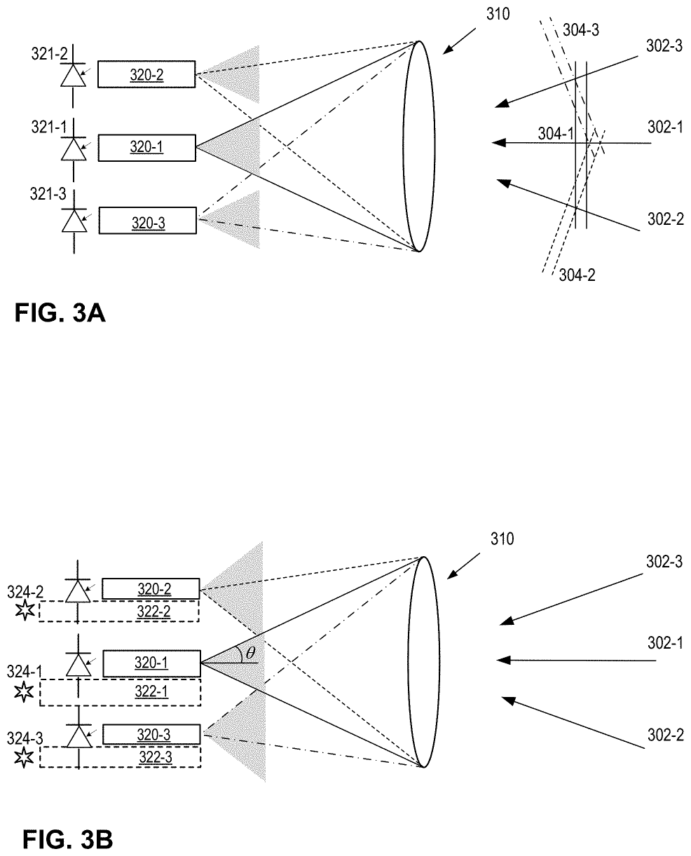

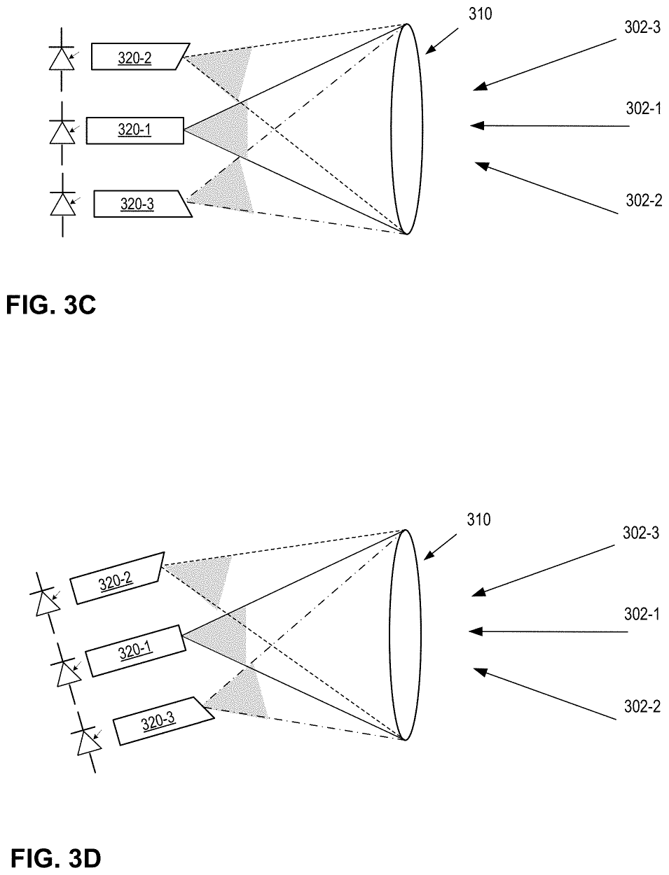

Various reflected beams 266 received by the RX interface 268 can arrive from different directions (e.g., along the direction of the respective output beam 264). Various reflected beams 266 can be focused by front-end optics (including one or more lenses, apertures, collimators, etc.) of RX interface 268 (or front-end optics shared by TX interface 262 and RX interface 268) and collected by separate optical communication lines, as described in more detail in conjunction with FIGS. 3-6. The collected beams can be processed as separate channels by a coherent detection stage 270 that includes one or more coherent light analyzers, such as balanced photodetectors (depicted with circles).

Each of the photodetectors can additionally receive an LO copy 240 of the corresponding output beam 264. Each balanced photodetector can detect a phase difference between two input beams, e.g., a difference between a phase of the LO 240 and a phase of the respective reflected beam 266. Balanced photodetectors can output electronic (e.g., RF) signals 271 representative of the information about the corresponding phase differences and provide the output electronic signals 271 to an RF demodulator 274. In some implementations, as depicted schematically, RF demodulator 274 can also receive an electronic signal 272, which can be a copy of the RF signal used by RF modulator 220 to impart phase or frequency modulation to the output beams 264. Although a single electronic signal 272 is depicted, in those implementations where some output beams 264 have unique modulation imparted by RF modulator 220, RF modulator 220 can provide to RF demodulator 274 as many different electronic signals 272 as are used to modulate various output beams 264. For example, the number of provided electronic signals 272 can be equal to the number of output beams 264, provided that each output beam 262 has a unique angle modulation. The difference between the phase of the electronic signal 272 and the respective electronic signal 271 output by coherent detection stage 270 can be representative of the velocity of the respective reflecting object 265 and the distance to the object 265. For example, the relative phase of the two signals can be indicative of the Doppler frequency shift Δf=2vf/c, which in turn depends on the velocity v of the object; with the positive frequency shift Δf>0 corresponding to object 265 moving towards the system 200 and the negative frequency shift Δf<0 corresponding to the object 265 moving away from the system 200. Furthermore, the relative phase of the two signals can be representative of the distance to object 265. More specifically, electronic signal 272 can include a sequence of features (e.g., chirp-up/chirp-down features) that can be used as time stamps to be compared to similar features of the electronic signal 271. The distance to object 265 can be determined from a time delay in the temporal positions of the corresponding features in the two signals associated with propagation of the transmitted and reflected beams to and from the object. More specifically, RF demodulator 274 can extract a beating pattern between the electronic signal 272 and the electronic signal 271, filtering out (e.g., using a low-pass filter) main RF carriers, amplifying the obtained signal, and the so on. The obtained low-frequency (baseband) signals 275 can then be digitized using an analog-to-digital converter (ADC) 180.

Digital signals 282 output by ADC 280 can undergo digital processing 290 to determine the Doppler shift and the velocity of different objects 265. Additionally, a distance to each object 265 can be extracted from a temporal shift (delay time) between frequency/phase modulation patterns of the electronic signal 271 and the electronic signal 272. Digital processing 290 can include spectral analyzers, such as Fast Fourier Transform (FTT) analyzers, and other circuits to process digital signals 282.

FIGS. 3A-3C are schematic depictions of example optimized coupling of multiple received reflected beams to OCLs for improved performance of lidar devices, in accordance with some aspects of the present disclosure. FIG. 3A depicts coupling of different received beams to on-axis and off-axis optical fibers that have similar configurations. Shown in FIG. 3A are multiple received beams 302-1, 302-2, 302-3 (only three beams are depicted although the number of received beams is not limited) incident on front-end optics 310. The front-end optics 310 is depicted as a single focusing lens for conciseness, but any number of focusing lenses, collimating lenses, apertures, polarizers, and other optical devices can be used. The front-end optics 310 can focus the received beams to different locations within a focal plane (or other focal surface) of the front-end optics 310. The focused beams can be focused on or near ends of optical fibers 320-x. As illustrated, received beam 302-1 is focused (as depicted with solid lines) on or near an end of optical fiber 320-1, received beam 302-2 is focused (as depicted with dashed lines) on or near an end of optical fiber 320-2, and received beam 302-3 is focused (as depicted with dot-dashed lines) on or near an end of optical fiber 320-3. (Also depicted with respective lines are wave fronts 304-1, 304-2, 304-3 of the corresponding received beams.) It should be understood that FIG. 3A (as well as other figures of this disclosure) depicts a cross-sectional view and that multiple additional optical fibers (or other OCLs) may be located outside the cross-sectional view. Accordingly, the ends of the optical fibers may form a two-dimensional array within a plane that is perpendicular to the optical axis of the front-end optics 310.

The right end of the optical fiber 320-1 is located at an optical axis of the front-end optics 310 while the right ends of other optical fibers (320-2 and 320-3) are laterally shifted away from the optical axis of the front-end optics 310. Each optical fiber 320-x guides collected focused beam 302-x to a respective light detector 321-x (which can be a part of coherent detection stage 270). Light detectors 321-x may be coherent light detectors, e.g., detectors containing one or more photodiodes or phototransistors, arranged in a balanced photodetection setup (as described in more detail above in connection with FIG. 2) that is capable of determining a phase different of the collected beam with a reference (e.g., local oscillator) beam. Light detectors 321-x may also include metal-semiconductor-metal photodetectors, photomultipliers, photoemissive detectors, and the like. In some implementations, light detectors may include solid-state photo-sensitive devices, such as silicon photomultipliers and single-photon avalanche diodes. Each optical fiber 320-x can have the same configuration, including the refractive materials from which the fiber is made, the cross-section (e.g., diameter) of the fiber, the type, orientation, quality of a surface of the end of the fiber, and so on. Consequently, each optical fiber 310-x can have the same (or similar) numerical aperture, indicated schematically by a shaded cone. The term “numerical aperture” refers to a range of angles of light that can be collected by a fiber (or any other OCL) and passed along the length of the fiber (e.g., to other components of the sensing system). Because of the same orientation of the surface of the fibers' ends, the optical fibers 320-x collect rays within regions of space that are substantially the same albeit laterally shifted from each other. As a result, if the numerical aperture of optical fiber 320-1 is selected to collect all (or most) focused rays of the received beam 302-1, some of the rays of focused received beams 302-2 and 302-3 (as well as other beams collected by off-center optical fibers not shown in FIG. 3A) can be uncollected (due to only a partial overlap of the shaded regions with the cones of the light incidence). Additionally, off-axis focusing can have optical aberration that is different from optical aberration of the on-axis focusing. Thus, a configuration of the optical fiber 320-1 selected to compensate (or reduce) effects of optical aberration of the on-axis focusing can result in less favorable conditions for off-axis detection of received beams 302-2, 302-3, . . . . On the other hand, correcting optical aberration by modifying the front-end optics 310 (or other optical elements), e.g., by improving lens design, increases cost and complexity of the optical system. Coupling of the off-axis received beams 302-2, 302-3, . . . to optical fibers 320-2, 320-3, . . . can be improved as described below in connection with FIGS. 3B-3D.

FIG. 3B depicts coupling of different received beams to on-axis and off-axis optical fibers that have different numerical apertures. Shown schematically in FIG. 3B off-axis optical fibers 320-2, 320-3, . . . have larger numerical apertures than the on-axis optical fiber 320-1. The numerical apertures of the off-axis fibers can be selected sufficiently broad to cover all (or most) rays of the focused received beams 302-2, 302-3, . . . (as depicted by the broadened shaded cones). The increase in the numerical apertures can be achieved by selecting optical fibers 320-2, 320-3, . . . of smaller radius than the optical fiber 320-1. For example, the angle from which the fiber collects light (e.g., half-angle of the accepted cone of light), can be increased, e.g., by making the fiber core diameter D smaller and the acceptance angle θ˜λ/D (with A standing for the wavelength of light). This can ensure that the full cross section of the portions of the received beams 302-2, 302-3, . . . that are captured by front-end-optics 310 are collected by the respective optical fibers.

The optical fibers 320-x (or any other OCLs, such as waveguides) can guide both the received beams 302-x and transmitted beams (not shown). In such a monostatic optical configuration, optical circulators or splitters can be used to separate light passing in opposite directions, for purposes of transmission and/or light detection. In some implementations, as depicted schematically in FIG. 3B, a bistatic optical configuration can be used. In a bistatic configuration, distinct OCLs can be used in TX and RX channels. For example, optical fibers 322-x can be used to guide light signals (schematically shown as produced by light sources 324-x) for transmission through the front-end optics 310. To ensure that light in the TX subsystem follows the optical path that is substantially the same as the optical path of the reflected light in the RX subsystem, optical fibers 322-x of the TX subsystem can be positioned close (e.g., as close as practicable for a given design) to the optical fibers 322-x of the TX subsystem. For brevity and conciseness, in other figures of this disclosure, only optical fibers (or other OCLs) of the RX subsystem are shown explicitly. However, it should be understood that additional TX OCLs can also be present if a bistatic configuration is used, e.g., similarly to the configuration depicted in FIG. 3B.

FIG. 3C depicts coupling of different received beams to on-axis and off-axis optical fibers that have different facet angles. Shown schematically in FIG. 3C off-axis optical fibers 320-2, 320-3, . . . have ends cut in a skewed fashion, such that a facet of the cut is oriented towards the respective focused received beam. As shown in FIG. 3C, different optical fibers can have similar numerical apertures but, by virtue of the angled facets, each off-axis optical fiber 320-2, 320-3, . . . is oriented towards the corresponding focused received beam 302-2, 302-3, . . . for maximum overlap with the cross-section of the corresponding beam. The tilt angle of each fiber's facet can be determined in view of the distance between the optical axis of the front-end optics 310 and the end of the respective fiber, the focal distance of the optical elements of the front-end optics 310, the diameter of the entrance pupil, and so on. For example, the larger the distance from the optical axis to the end of the fiber, the larger (e.g., proportionally to the distance) the tilt angle of the facet can be.

FIG. 3D depicts coupling of different received beams to optical fibers that have different facet angles and a net angle tilt. An angle tilt can be used for improved coupling of light to the optical fibers. For example, the net angle tilt of various optical fibers may be used to reduce reflection. In some implementations, reduction in reflection can be achieved for polarized light when the tilt angle is chosen to make the angle of incidence near Brewster's angle for the optical fiber material. Although, for simplicity, all optical fibers 320-x are tilted to the same angle in FIG. 3D, in some implementations, different optical fibers can be tilted to different angles.

In addition to ends of the optical fibers having different numerical apertures and facet angles, the ends of the optical fibers can be coated with anti-reflective material, to improve coupling of the received beams to the fibers.

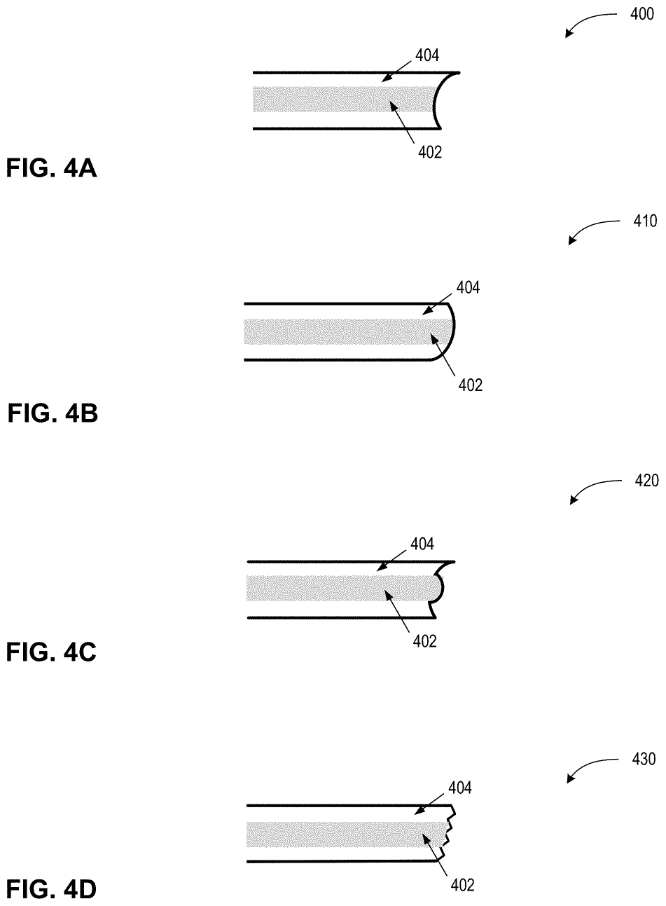

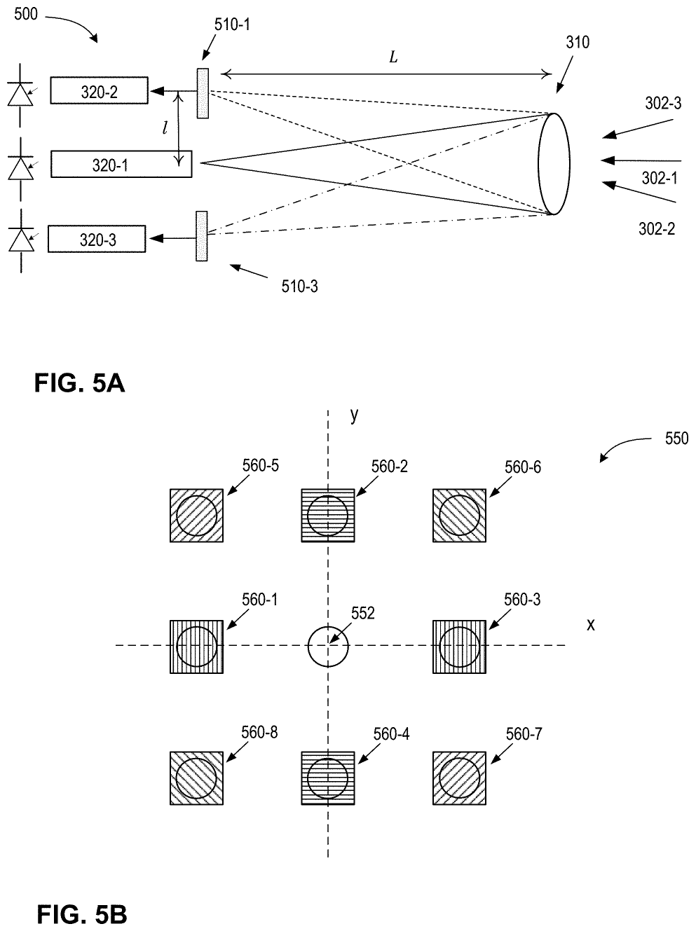

FIGS. 4A-4D are schematic depictions of example geometries of coupling portions of off-axis optical fibers for improved coupling to received beams in lidar devices, in accordance with some aspects of the present disclosure. FIG. 4A depicts a coupling portion 400 having a concave end. The coupling portion 400 can belong to optical fiber 320-2 of FIGS. 3A-3C (or some other off-axis fiber). The coupling portion 400 can include fiber optic core 402 (depicted with a shading) and cladding 404. The coupling portion 400 (or a similar coupling portion) can be used in implementations in which the light from a received beam is focused at some point in front of the concave end of the optical fiber, to improve collection of light of the received beam. The collected light can then be guided by the optical fiber to a light detector (e.g., a photodetector of coherent detection stage 270 in FIG. 2). FIG. 4B depicts a coupling portion 410 having a convex end. The coupling portion 410 can also include fiber optic core 402 and cladding 404 and can be used in implementations in which the light from the received beam is focused at some point inside the coupling portion 410. FIG. 4C depicts a coupling portion 430 having multiple curvatures, such as a convex curvature for fiber optic core 402 and a concave curvature for cladding 404. The coupling portion 420 can be used in implementations in which the light from the received beam is focused inside the coupling portion 410 while controlling the intake of light through the cladding of the optical fiber. FIG. 4D depicts a coupling portion 430 that has a modulation (e.g., grating) etched on (or otherwise imparted to) the end of the fiber. The etched modulation can be engineered to improve directional coupling of the received (and focused) beam approaching at an angle to the fiber's axis. Coupling portion 430 with etched modulation can operate similarly to diffraction optical elements discussed in conjunction with FIG. 5A.

FIG. 5A depicts schematically an example setup 500 that deploys diffractive optical elements for improved coupling of multiple reflected beams to optical communication lines in lidar devices, in accordance with some aspects of the present disclosure. Diffractive optical element (DOE) 510-2 can collect focused received beam 302-2 and direct the collected beam to the optical fiber 320-2. DOE 510-2 can be configured to produce a maximum of transmitted light in the direction of optical fiber 320-2. For example, if DOE 510-2 includes a diffraction grating, the spacing between the slits d can be set in view of the location of the optical fiber 320-2. If the optical fiber 320-2 is located at a lateral distance l from the optical axis and at a longitudinal distance L from the focusing front-end optics 310, the focused beam can approach DOE 510-2 at an angle α=l/L. The spacing of the grating can, therefore, be set at d=λ/sinα, which corresponds to the first principal maximum of the transmitted light. In some implementations, DOE 510-2 can be configured to direct the second (d=2λ/sinα) or the third (d=3λ/sinα), etc., maximum to the optical fiber 320-2. Because DOE 510-2 can be positioned to direct diffracted light along the axis of the optical fiber 320-2, the front end of the optical fiber 320-2 can be engineered similarly to the on-axis optical fiber 320-1. In some implementations, as depicted, the optical fiber 320-1 receives the focused beam 302-1 directly, without an intervening DOE. Other optical fibers, e.g., optical fiber 320-3, can be similarly outfitted with DOEs, which can be configured differently depending on the distances land L for the respective optical fibers. Although the example setup 500 is discussed with optical fibers used as an illustration, it should be understood that any other OCL capable of delivering optical signals to other components of the lidar sensing system, such as a waveguide, can be used instead.

FIG. 5B depicts schematically an example array 550 of multiple diffractive optical elements configured to improve coupling between reflected beams and OCLs in lidar devices, in accordance with some aspects of the present disclosure. FIG. 5B illustrates a schematic rear-facing view from the vantage point of the front-end optics. Shown are eight DOEs 560-x (depicted with squares); each of the depicted DOEs can be positioned in front of a communication line (depicted with a circle). Each of the DOEs can have a phase-forming structure designed to compensate for the off-axis focusing of the respective received beams. For example, DOEs 560-1, 560-2, 560-3, and 560-4 can be positioned closest to the optical axis and can have structures (e.g., diffraction gratings) that direct some of the principal maxima of transmitted light parallel to the optical axis. In particular, DOE 560-1 can be configured to diffract a beam having a component of the wave vector along the x-axis to the direction parallel to the optical axis (z-axis) with no x- or y-components of the wave vector of the diffracted beam. Likewise, DOEs 560-5, 560-6, 560-7, and 560-8 can be positioned farther away from the optical axis and can have diffraction structures designed to diffract beams having wave vector components along both the x-axis and the y-axis in a direction parallel to the optical axis with no x- or y-components of the wave vector of the diffracted beam. In some implementations, some or all of DOEs 560-x can be (or include) a holographic plate, a vortex wave plate, a forked diffraction grating, a spatial light modulator, or any other diffractive optical elements capable of redirecting received beams. In some implementations, the on-axis optical fiber (or waveguide) 552 can receive the corresponding incident beam directly, without an intervening DOE.

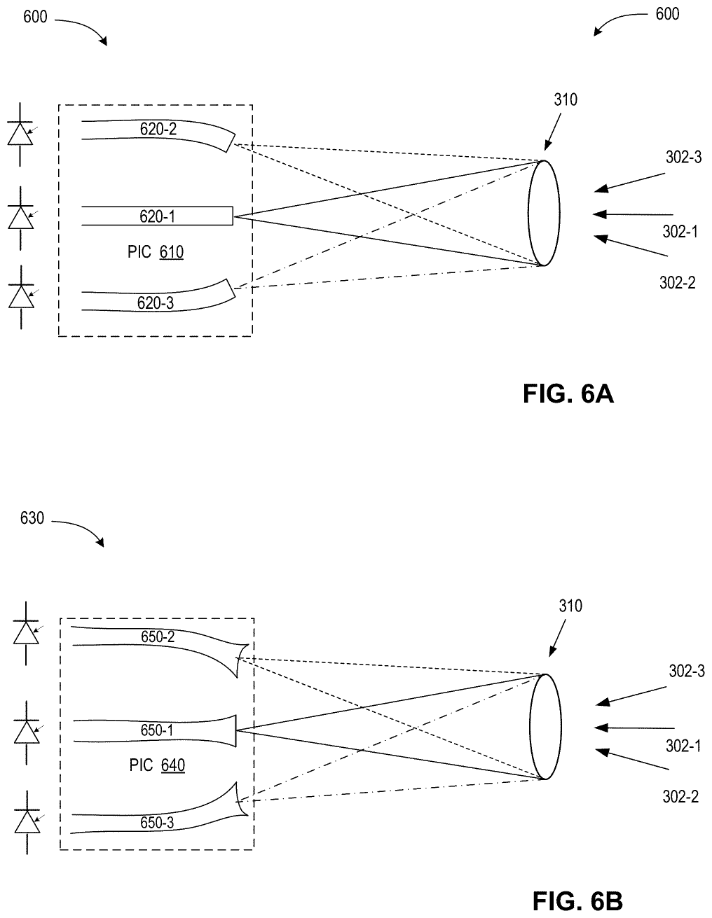

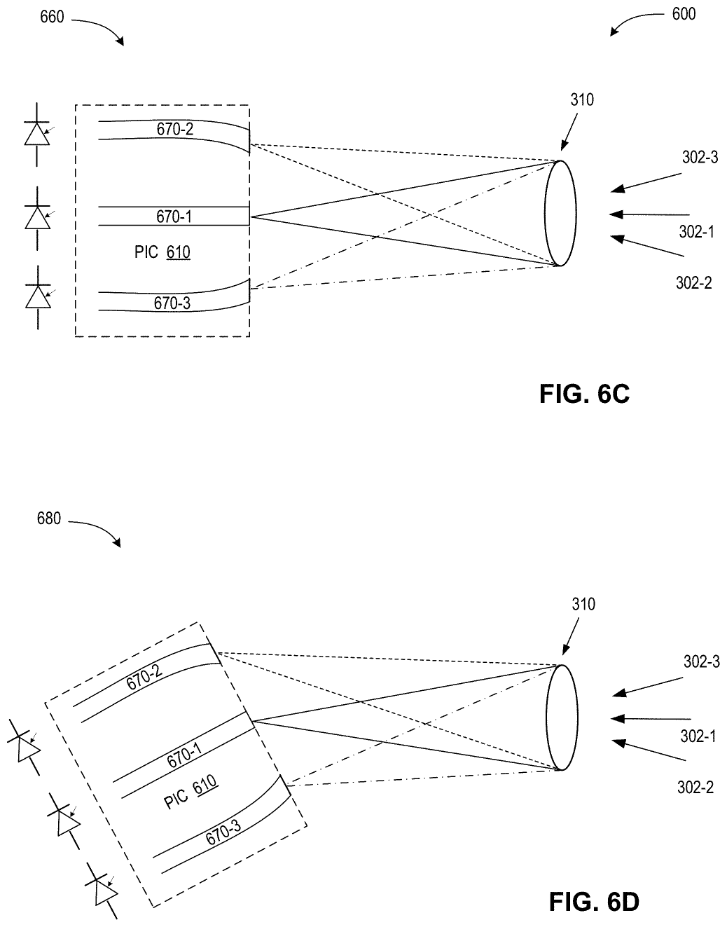

FIG. 6A depicts schematically an example system 600 of OCLs implemented as part of a photonic integrated circuit (PIC), in accordance with some aspects of the present disclosure. Illustrated is a PIC 610 that can integrate multiple waveguides (or other OCLs) 620-x, e.g., 620-1, 620-2, 620-3, and so on. Although three waveguides are depicted for brevity and conciseness, any number of waveguides can be integrated on a single PIC 610. Waveguides 620-x can have front openings that are configured to have maximum coupling to respectively receive (and focus) beams 302-x. For example, the axes of the waveguides 620-x can be aligned with the received (and focused) beams 302-x. FIG. 6B depicts schematically another example system 630 of OCLs implemented as part of a photonic integrated circuit (PIC), in accordance with some aspects of the present disclosure. Shown is a PIC 640 with tapered waveguides 650-x having front openings of gradually increasing cross-sections for improved collection of received beam 302-x. FIG. 6C depicts schematically yet another example system 660 of OCLs implemented as part of a PIC, in which waveguide openings are inline with an edge of the photonic integrated circuit, in accordance with some aspects of the present disclosure. More specifically, the ends of waveguides 670-1, 670-2, and 670-3 (and others that are not shown explicitly) may be obtained using PIC lithography with subsequent cleaving to obtain an edge of PIC 610 that also defines a plane of waveguide openings. FIG. 6D depicts schematically yet another example system 680 of OCLs implemented as part of a PIC, in which OCLs have a net angle tilt, in accordance with some aspects of the present disclosure.

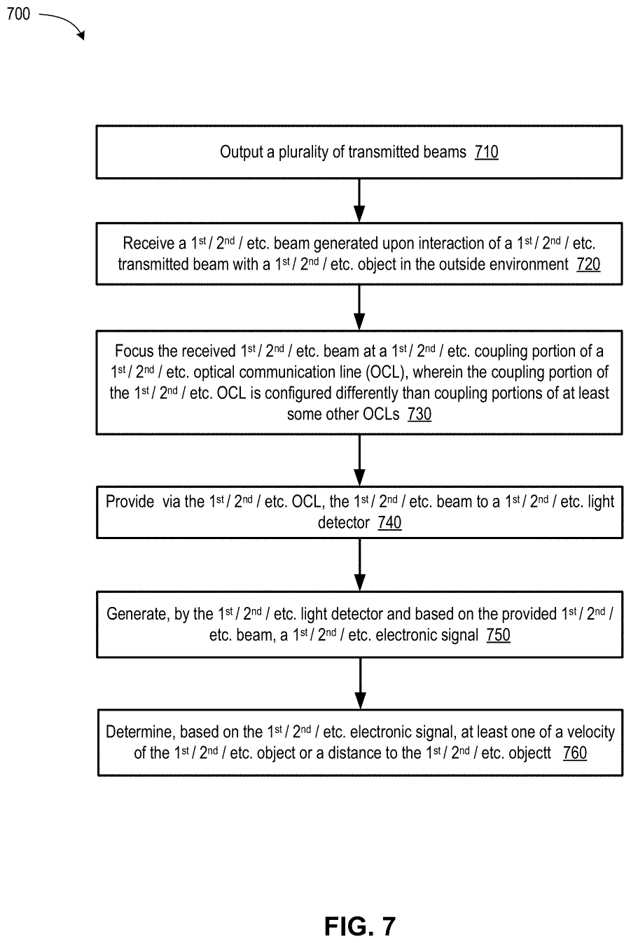

FIG. 7 depicts a flow diagram of an example method 700 of using an optical sensing system that utilizes optimized processing of multiple sensing channels for efficient and reliable scanning of environments, in accordance with some aspects of the present disclosure. Method 700 can be performed by a sensing system 120 that includes OMRT 124. Method 700 can be performed using systems and components described in relation to FIGS. 2-6, e.g., by the optical sensing system 200 incorporating various OCLs depicted in FIGS. 3-6. Method 700 can be performed using an optical transmission (TX) subsystem and an optical reception (RX) subsystem in a bistatic or a monostatic configuration. In the bistatic configuration, the TX subsystem and the RX subsystem can be separate subsystems deploying separate optical components. In the monostatic configuration, various components can be shared between the TX and RX subsystems. Shared devices and elements can include front-end-optics, OCLs (e.g., fibers and/or waveguides), amplifiers, and the like. The separation of transmitted and reflected light can be achieved in the monostatic configuration using one or more beam splitters, optical circulators and other optical elements.

In some implementations, method 700 can be used for determination of range and velocity of objects in autonomous vehicle environments. Method 700 can be used to improve coverage, resolution, and speed of detection of objects and their state of motion with lidar devices. Method 700 can include outputting, at block 710, a plurality of transmitted beams (e.g., beams 264 in FIG. 2) towards one or more objects in an outside environment (e.g., object 265 in FIG. 2) using TX optical subsystem (TX interface 262 in FIG. 2) or a combined TX/RX optical subsystem. Each or some of the transmitted beams can include a low-frequency (compared with the frequency of the optical carrier) modulation, e.g., an RF modulation or a microwave frequency modulation. Modulation can be any type of angle modulation, including phase modulation, frequency modulation, or any combination thereof. In some implementations, modulation can also include an amplitude modulation. Modulation imparted can be the same for all transmitted beams or can be different for at least some (or all) transmitted beams. The angle modulation can be performed by an electronic (e.g., RF) circuit (e.g. RF modulator 220 in FIG. 2) configured to impart an angle modulation to the beam transmitted towards the object. Local copes (e.g., LOs 240 in FIG. 2) of the transmitted beams can remain accessible to the optical sensing system for use with the received reflected beams.

At block 720, method 700 can continue with an optical subsystem, e.g. RX subsystem (RX interface 268 in FIG. 2) or a combined TX/RX optical subsystem, receiving, from the outside environment, a first/second/etc. reflected beam. The received beams can be generated upon interaction of a first/second/etc. transmitted beam with a first/second/etc. object in the outside environment. The interaction with the respective object refers to physical processes that occur in that object (e.g., on or near the surface of the object), such as a motion of charged particles of the object that generate a reflected wave.

At block 730, method 700 can continue with focusing the received first/second/etc. beam at a first/second/etc. coupling portion of a first/second/etc. OCL of a plurality of OCLs. The coupling portion of the first OCL can be configured differently than coupling portions of the second/third/etc. OCLs. Configuration of the coupling portion should be understood as including both a structure of the coupling portion and a positioning of the coupling portion. For example, the structure can include physical materials used in making the OCL (e.g., the walls of a waveguide, the core/cladding of an optical fiber), the size of the OCL (e.g., a diameter, a shape of a cross-sectional area of the OCL, a form of the opening/end of the coupling portion of the OCL), and the like. The positioning of the coupling portion can include a distance from an optical axis of the front-end optics, the orientation of the coupling portion (e.g., facet angle) relative to the focal plane of the front-end optics, and so on. In some implementations, multiple OCLs may have similar physical properties (e.g., OCLs that are located at the same distance from the optical axis of the front-end optics can have similar properties) but have coupling portions positioned differently. For example, each coupling portion can have a facet that is angled towards a specific focused beam directed to a particular OCL.

Various configurations of OCL coupling portions can be used. In some implementations, some or all OCLs are optical fibers and the OCL coupling portions include an end facet of an optical fiber. The end facet can make an angle with an axis of the optical fiber that is specific for the optical fiber and is set in view of a distance of the end facet from the optical axis of the front-end optics (e.g., as depicted in FIG. 3C). In some implementations, the coupling portion includes an end of an optical fiber that has a numerical aperture set in view of the distance of the end of the optical fiber from the optical axis of the front-end optics (e.g., as depicted in FIG. 3B). In some implementations, the coupling portion can include an end facet that has a curved surface (e.g., as depicted in FIGS. 4A-4C).

In some implementations, some or all OCLs are waveguides and the OCL coupling portions include an opening of a waveguide. In some implementations, the waveguide is curved to a degree determined in view of a distance of an opening of the waveguide from an optical axis of the front-end optics (e.g., as depicted in FIG. 6A). In some implementations, the coupling portion includes an opening of a tapered waveguide (e.g., as depicted in FIG. 6B).

In some implementations, some or all OCLs are equipped with additional optical elements. For example, the OCL coupling portion can include a diffractive optical element (DOE) configured to direct the corresponding received (and focused) beam towards a waveguide opening or towards an end of an optical fiber, depending on the specific type of the OCL being used. In some implementations, the DOE can include a grating structure having a spatial orientation that is set in view of a direction from the optical axis of the front-end optics to the DOE (e.g., as depicted in FIGS. 5A-5B). In some implementations, at least some (or all) OCLs are integrated into a photonic integrated circuit (PIC). In some implementations, the coupling portions of some (or all) OCLs are located near a focal plane of the front-end optics, to maximize the intake of the received beams.

At block 740, method 700 can continue with providing the first/second/etc. beam to a respective light detector. For example, each OCL can have a guiding portion (e.g., a body of the waveguide/fiber) connected to the coupling portion. The light carried by the guiding portion of the OCL can be delivered to the light detector. At block 750, method 700 can continue with the first/second/etc. detector generating, based on the provided beam, a first/second/etc. electronic signal. The first/second/etc. light detector can also be configured to receive a local oscillator copy of a corresponding (e.g., first/second/etc.) beam transmitted to the outside environment. The detector can generate data representative of a difference between a phase of the local oscillator copy and a phase of the detected beam. For example, each light detector can include one or more balanced photodetectors having photodiodes connected in series and generating ac electric signals that are proportional to a difference of the electromagnetic field of the two input beams.

At block 760, method 700 may continue with one or more circuits of the sensing system, operatively coupled with the light detectors, determining, based on the first/second/etc. electronic signal, a velocity of the first/second/etc. object and/or a distance to the first/second/etc. object. For example, the electronic signal can have a frequency Δf=f_{R}−f_{T} corresponding to the beating pattern (Doppler shift) between a frequency f_{R} of the received beam and a frequency f_{T} of the transmitted signal. Based on the detected frequency Δf, the one or more circuits of the sensing system can determine the (radial) velocity of the object v=cΔf/2f_{T}. The one or more circuits can include a processing device, such as a central processing unit (CPU), a field-programmable gate array (FPGA), an application-specific integrated circuit (ASIC), or some other type of a processing device. Similarly, the electronic signal can carry information about the distance to the object. For example, the transmitted signal can have a series of frequency (or phase) features, such as a sequence of frequency up-chirps f_{T}(t)=f_{T}+αt interspersed with a sequence of down-chirps f_{T}(t)=f_{T}−αt (although linear chirps are used for illustration, any other frequency/phase features can be used), such that the sign of the chirp is reversed at a sequence of time instances t₁, t₂, . . . tⱼ, . . . (e.g., tⱼ=j·τ). The received beams can have the chirp structure that reverses the sign at a sequence of times that are delayed t₁−Δt, t₂−Δt, . . . tⱼ−Δt, . . . by some time delay Δt relative to the transmitted beam. Having identified that the frequency (or phase) features in the received beam are delayed by some time Δt, the one or more circuits can determine that the distance to the object is L=c×t/2, which is the distance covered by light over one half of the total delay time (time of flight) M. Because time delays are distinct modulo 2τ (one period of the chirp-up/chirp-down cycle), the distance to the object can be determined up to increments of 2cτ (such that if 2cτ=400 m, and cΔt/2=160 m, the object can potentially be located at distance of 160 m, 560 m, 960 m, and so on). Further disambiguation of the distance can be performed based on the strength of the received signal (whose known dependence on the range can be quite sufficient to distinguish between signals reflected from objects positioned several hundred meters away).

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems can be used with programs in accordance with the teachings herein, or it can prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

1. A system comprising:
a front-end optics configured to focus a plurality of received beams;
a plurality of optical communication lines (OCLs), wherein each OCL in the plurality of OCLs is configured with a coupling portion to collect a corresponding beam of the focused plurality of received beams, wherein the coupling portion of a first OCL in the plurality of OCLs is configured differently than the coupling portion of a second OCL in the plurality of OCLs; and
a plurality of light detectors, wherein each of the plurality of light detectors is configured to:
detect a respective beam of the plurality of beams collected by the coupling portion of a respective OCL in the plurality of OCLs; and
generate, based on the detected beam, data representative of at least one of (i) a velocity of an object that generated the detected beam or (ii) a distance to the object that generated the detected beam.

2. The system of claim 1, wherein the coupling portion of the first OCL comprises an end facet of an optical fiber, wherein the end facet makes an angle with an axis of the optical fiber, and wherein the angle is determined in view of a distance of the end facet from an optical axis of the front-end optics.

3. The system of claim 1, wherein the coupling portion of the first OCL comprises an end of an optical fiber, wherein the end of the optical fiber has a numerical aperture that is determined in view of a distance of the end of the optical fiber from an optical axis of the front-end optics.

4. The system of claim 1, wherein the coupling portion of the first OCL comprises an end facet of an optical fiber, and wherein the end facet of the optical fiber has a curved surface.

5. The system of claim 1, wherein the coupling portion of the first OCL comprises an opening of a waveguide, wherein the waveguide is curved to a degree determined in view of a distance of an opening of the waveguide from an optical axis of the front-end optics.

6. The system of claim 1, wherein the coupling portion of the first OCL comprises an opening of a tapered waveguide.

7. The system of claim 1, wherein the coupling portion of the first OCL comprises a diffractive optical element (DOE) configured to direct the corresponding beam of the plurality of received and focused beams towards at least one of a waveguide opening or an end of an optical fiber.

8. The system of claim 7, wherein the DOE comprises a grating structure having a spatial orientation that is set in view of a direction from an optical axis of the front-end optics to the DOE.

9. The system of claim 1, wherein the coupling portion of each of the plurality of OCLs is located near a focal plane of the front-end optics.

10. The system of claim 1, wherein each of the plurality of light detectors is further configured to receive a local oscillator copy of a beam transmitted to an environment that comprises the object, and wherein to generate the data, a respective light detector is to determine a difference between a phase of the local oscillator copy and a phase of the detected beam.

11. The system of claim 1, wherein the plurality of OCLs are integrated on a photonic integrated circuit.

12. The system of claim 1, wherein the first OCL comprises at least one of an optical fiber portion, a waveguide portion, or a photonic-crystal fiber portion.

13. A sensing system comprising:
an optical subsystem configured to:
output, to an outside environment, a plurality of transmitted beams;
receive, from the outside environment, a first beam generated upon interaction of a first transmitted beam of the plurality of transmitted beams with a first object in the outside environment; and
focus the received first beam at a first coupling portion of a first optical communication line (OCL) in a plurality of OCLs, wherein the coupling portion of the first OCL is configured differently than the coupling portion of a second OCL in the plurality of OCLs;
a light detection subsystem configured to:
obtain, via the first OCL, the first beam; and
generate, based on the obtained first beam, a first electronic signal; and
one or more circuits, operatively coupled with the light detection subsystem and configured to determine, based on the first electronic signal, at least one of a velocity of the first object or a distance to the first object.

14. The sensing system of claim 13,
wherein the optical subsystem is further configured to:
receive, from the outside environment, a second beam generated upon interaction of a second transmitted beam of the plurality of transmitted beams with a second object in the outside environment; and
focus the received second beam at the coupling portion of the second OCL;
wherein the light detection subsystem is further configured to:
obtain, via the second OCL, the second beam; and
generate, based on the obtained second beam, a second electronic signal; and
wherein the one or more circuits are further configured to:
determine, based on the second electronic signal, at least one of a velocity of the second object or a distance to the second object.

15. The sensing system of claim 13, wherein the coupling portion of the first OCL comprises an end facet of an optical fiber, wherein the end facet makes an angle with an axis of the optical fiber, and wherein the angle is determined in view of a distance of the end facet from an optical axis of the optical subsystem.

16. The sensing system of claim 13, wherein the coupling portion of the first OCL comprises an end of an optical fiber, wherein the end of the optical fiber has a numerical aperture that is determined in view of a distance of the end of the optical fiber from an optical axis of the optical subsystem.

17. The sensing system of claim 13, wherein the coupling portion of the first OCL comprises an opening of a waveguide, and wherein the waveguide is curved to a degree determined in view of a distance of the opening of the waveguide from an optical axis of the optical subsystem.

18. The sensing system of claim 13, wherein the coupling portion of the first OCL comprises a diffractive optical element (DOE) configured to direct the focused first beam towards at least one of a waveguide opening or an end of an optical fiber.

19. A method comprising:
outputting, to an outside environment, a plurality of transmitted beams;
receiving, from the outside environment, a first beam generated upon interaction of a first transmitted beam of the plurality of transmitted beams with a first object in the outside environment;
focusing the received first beam at a coupling portion of a first optical communication line (OCL) in a plurality of OCLs, wherein the coupling portion of the first OCL is configured differently than the coupling portion of a second OCL in the plurality of OCLs;
providing, via the first OCL, the first beam to a first light detector;
generating, using the first light detector and based on the provided first beam, a first electronic signal; and
determining, based on the first electronic signal, at least one of a velocity of the first object or a distance to the first object.

20. The method of claim 19, further comprising:
receiving, from the outside environment, a second beam generated upon interaction of a second transmitted beam of the plurality of transmitted beams with a second object in the outside environment;
focusing the received second beam at the coupling portion of the second OCL;
providing, via the second OCL, the second beam to a second light detector;
generating, using the second light detector and based on the provided second beam, a second electronic signal:
determining, based on the second electronic signal, at least one of a velocity of the second object or a distance to the second object.

21. The method of claim 19, wherein the coupling portion of the first OCL comprises an end of an optical fiber, the end of the optical fiber having at least one of:
(i) a facet making an angle, with an axis of the optical fiber, that is determined in view of a distance of the facet from an optical axis of an optical subsystem that focuses the received first beam, or
(ii) a numerical aperture that is determined in view of a distance of the end of the optical fiber from the optical axis of the optical subsystem.
